(19) United States
(12) Patent Application Publication
(10) Pub. No.: US 2010/0065195 A1
(43) Pub. Date: Mar. 18, 2010

(54) METHOD FOR MANUFACTURING A COATED COMPONENT

(76) Inventor: Paeivi Lehtonen, Fellbach (DE)

Correspondence Address: KENYON & KENYON LLP, ONE BROADWAY, NEW YORK, NY, 10004, US

(21) Appl. No.: 11/922,053

(22) PCT Filed: Jun. 14, 2006
(86) PCT No.: PCT/EP2006/063185

§ 371 Date: Dec. 3, 2009

(30) Foreign Application Priority Data
Jul. 6, 2005 (DE) 102005031606.9

(51) Int. Cl. B32B 27/06

(52) U.S. Cl. 156/242

(57) ABSTRACT

A method for manufacturing a component coated using a thermoplastic layer, the method including: providing the component, applying an intermediate layer made of a plastic to at least a part of the component, performing a plasma treatment of the intermediate layer using a plasma gas, the molecules or the structure of the molecules of the intermediate layer being modified at least on the surface of the intermediate layer, and injection molding the thermoplastic layer in such a way that the thermoplastic layer and the component provided with the intermediate layer adhere to one another non-positively.

### FIELD OF THE INVENTION

The present invention relates to a method for manufacturing a component coated using a thermoplastic layer.

### BACKGROUND INFORMATION

Components which are coated by a thermoplastic layer are commonly found in industrial manufacturing. A conventional injection molding method may be used for their manufacture, in which plastic molded parts are basically manufactured from molding compounds. For example, powdered or granulated injection molding compounds are plasticized by an injection molding machine and injected at high pressure into the molding cavity of an injection mold, for example.

In addition, injection molding methods are particularly suitable for bonding multiple components in one work cycle, both different and also identical materials being able to be bonded to one another. Multiple individual parts to be bonded to one another may be pre-finished and then joined using plastic. Reference is made in this context to the so-called hybrid, insert, and outsert technologies, which are based on the insertion of metallic structures into the injection molds and subsequent coating or extrusion coating of the metallic structures using thermoplastics. Vehicle body parts in automobile construction such as front ends, metal bushings extrusion coated using thermoplastics, or metallic pins for electronic switching devices of greatly varying types are cited here as representatives.

Technical problems may result if the thermoplastic melt is applied to metal parts whose temperature is significantly below the melting point of the thermoplastic. A thin layer made of solidified, i.e., quenched, thermoplastic material forms immediately in the melt at the interface to the metal, which does not adhere to the metal. Because the entire melt additionally solidifies with reduction of its volume in the injection mold during the further cooling process, at least partial detachment of the thermoplastic layer from the metal surface results therefrom. While this effect does ensure good ability to demold the thermoplastics from metallic injection molds on the one hand, it makes liquid-tight or gas-tight extrusion coating of metallic insert parts such as the pins in plugs and control units more difficult on the other hand. In comparison to an adhesive bond or an extrusion coating using duroplastic epoxide molding compounds, no noteworthy adhesion forms between the thermoplastic and the metallic insert part upon extrusion using thermoplastics. The adhesion, which is slight in any case, does not permit any transmission of tensile or shear strength. In addition, thin gaps also arise between the extrusion-coated metal parts and the thermoplastic.

Therefore, post-processing is necessary on already-coated components. Frequently, low-viscosity casting compounds based on epoxide resins or silicones are used, which penetrate into the undesired gaps and ideally adhere to the metals and thermoplastics.

Alternatively, a layer made of a hot-melt adhesive may first be applied to hot metallic components, in order to subsequently extrusion coat the components using thermoplastic. However, the low temperature resistance and solvent resistance of the hot-melt adhesives are disadvantageous in this approach. Both properties may be improved if a hot-melt adhesive which is thermally cross-linked later is used, but then the entire composite component must be stored for some time at an elevated temperature after the extrusion coating of the components using thermoplastic. In some circumstances, flaws arise in the composite component at very high temperatures, for example on electronic components inside the composite component.

A further possibility for solving the problem of poor adhesion is to provide an adhesion promoter layer between the component and the external thermoplastic layer. Thus, a method is described in German Patent Application No. DE 103 61 096.0, according to which an adhesion promoter layer is applied to metallic components in a first step. Subsequently, in a second step, the extrusion coating of the thermoplastic layer is performed on the component which is now covered by the adhesion promoter layer, the adhesion promoter layer being welded to the thermoplastic layer in such a way that no gaps occur between the metallic component and the thermoplastic layer and a non-positive bond is provided between the thermoplastic layer and the adhesion promoter layer and thus finally also between the thermoplastic layer and the metallic component.

At least two conditions must be fulfilled for this purpose to be achieved: the interface temperature between the thermoplastic melt and the adhesion promoter layer occurring during the extrusion coating procedure must be sufficiently high for the welding process. In addition, the two layers to be bonded must be compatible with one another, i.e., must be fundamentally weldable to one another.

In many applications, still further requirements, such as resistance to surrounding media, in particular at high temperatures, are additionally to be placed on the materials to be bonded. These different conditions partially result in contradictory requirements on the materials. On the one hand, the softening temperature of the adhesion promoter layer is to be sufficiently low to ensure good welding to the thermoplastic extrusion coating; on the other hand, it is to be sufficiently high to have good temperature and media resistance.

Finally, the adhesion promoter layer must be elastic and its thermal expansion coefficient and its thickness must have a specific relationship to the corresponding values of the metal and thermoplastic layers. Alternatively, the adhesion promoter layer may be implemented as volume-compressible.

A significant restriction of the selection of the materials for the adhesion promoter layer and the thermoplastic layer results from the boundary conditions listed above.

Furthermore, a layer composite on a metallic component is described in U.S. Pat. No. 6,620,517 B2, a rubber layer, an adhesion layer, and a thermoplastic layer being applied consecutively to the component for its manufacture. After the application of the rubber layer, it is vulcanized and a plasma treatment is possibly performed on the surface of the vulcanized rubber layer. Such plasma treatments, predominantly using noble gas plasmas, are known to be used for surface cleaning of the layer to be treated, the molecules of the layer to be treated not being changed in their structure, but rather contaminants typically being removed from the layer.

### SUMMARY

An example method for manufacturing a component coated using a thermoplastic layer according to the present invention may have the advantage that the adhesion of the thermoplastic layer to the component is significantly strengthened or made possible for the first time. Namely, it has been found experimentally that even with material combinations which are otherwise incompatible, good adhesion has been achieved using the example method according to the present invention. A greater selection of usable materials results therefrom. It is advantageous that the example method does not require additional significant technical outlay, so that it may be performed cost-effectively. The high quality of the finished components also contributes to the cost-effectiveness of the method: the components coated using a thermoplastic layer are gas-tight and liquid-tight after the extrusion coating, so that subsequent processing for sealing the components is not necessary.

Moreover, it has been found that the example method is not only suitable for metallic components, but also for components made of duroplastic materials.

### BRIEF DESCRIPTION OF THE DRAWINGS

Exemplary embodiments of the present invention are explained in greater detail below.

FIG. 1 shows, in a sectional view, a coated component manufactured according to an example embodiment of the present invention having an intermediate layer between the component and the thermoplastic layer.

FIG. 2 shows, in a sectional view, a further coated component manufactured according to an example embodiment of the present invention having an intermediate layer between the component and the thermoplastic layer, the intermediate layer being provided with a thin adhesive layer.

### DETAILED DESCRIPTION OF EXAMPLE EMBODIMENTS

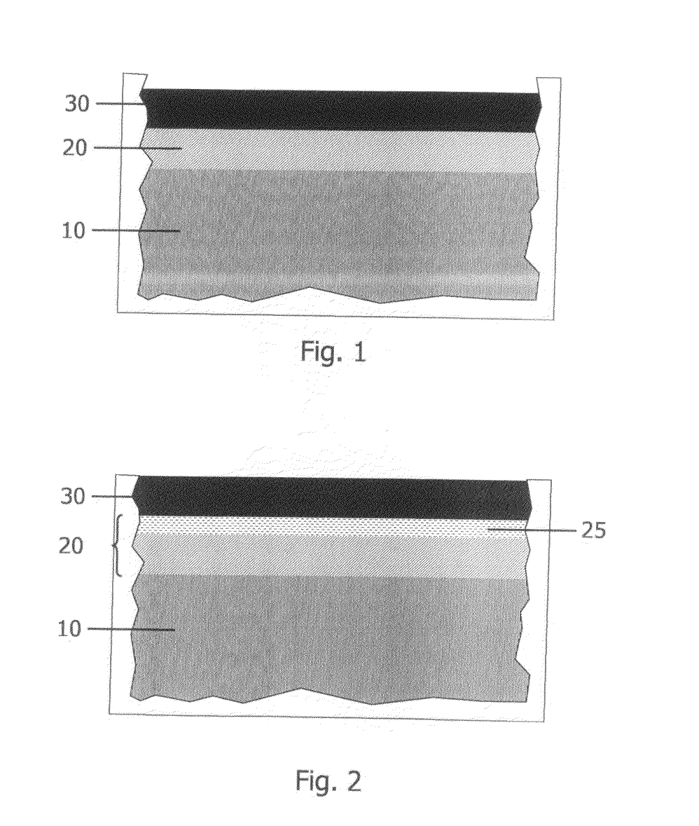

An example method according to the present invention is based on the finding that the adhesion of a thermoplastic layer to a component is greatly improved or is made possible for the first time by a targeted plasma treatment of an intermediate layer between the component and the thermoplastic layer. FIG. 1 shows a component manufactured using the example method. The following steps are provided for manufacturing a component coated using a thermoplastic layer:
a) providing component (10),
b) applying an intermediate layer (20) made of a plastic to at least a part of component (10),
c) performing a plasma treatment of intermediate layer (20) using a plasma gas, the molecules or the structure of the molecules of intermediate layer (20) being modified at least on the surface of intermediate layer (20), and
d) injection molding thermoplastic layer (30) in such a way that thermoplastic layer (30) and component (10) provided with intermediate layer (20) non-positively adhere to one another.

Component (10) to be coated is provided in step a). The component is typically made of a metallic material, but may also include a duroplastic material.

Subsequently, in step b), an intermediate layer (20) made of a plastic is applied to at least a part of component (10). The plastic may be a thermoplastic such as polyamide, a thermoplastic elastomer (TPE) such as polyether block amide (PEBA), an elastomer such as vulcanized rubber, or a cross-linked silicone. Thermoplastic elastomers (TPE), fluorinated rubber, or also fluorinated silicone are particularly important. These materials are therefore of interest because they are resistant to media and high temperatures. Intermediate layer (20) ideally has a thickness of 10 μm to a few hundreds of micrometers, at most approximately 1 mm. This large selection of materials for intermediate layer (20) and thus of material combinations of intermediate layer (20)/thermoplastic layer (30) is made possible only by the subsequent plasma treatment of intermediate layer (20).

During the plasma treatment in step c), the molecules or the structure of the molecules of intermediate layer (20) are modified at least on the surface of intermediate layer (20). Fundamentally, intermediate layer (20) may be treated using a low-pressure or atmospheric-pressure plasma. In the first case, the processing pressure is advantageously approximately 0.1 to 0.5 millibar, in particular 0.3 millibar. In contrast, if one uses an atmospheric-pressure plasma, a vacuum chamber may be dispensed with and components may be moved directly to an injection molding machine through a plasma lance using a robot, for example. A gas mixture which contains silane, for example, or pure oxygen is used as the plasma gas for the plasma treatment. Furthermore, argon may be added as a protective gas.

The plastic surface may be modified in various ways depending on the composition of the plasma gas. With reactive plasmas, a surface layer made of components of the plasma gas may form. Fragments of the plasma gas such as oxygen (oxidation) may be incorporated by the plasma treatment, at least in the surface area of intermediate layer (20). By incorporating foreign atom and/or molecule groups from the plasma gas in the plastic surface, it is also possible to transfer the molecules of intermediate layer (20) into a state having a higher polarity by the plasma treatment. If the structure of the molecules of intermediate layer (20) has linear molecular chains, the molecular chains may be shortened by the plasma treatment. Finally, the possibility also exists of forming reactive groups, such as reactive ions, or radicals via the plasma treatment at least in the surface area of intermediate layer (20) itself, which chemically bond to the coated thermoplastic layer. Plasma gases are thus used in such a way that plasma gas fragments form reactive or adhesion-promoting groups on the plastic surface.

An intermediate layer (20) surface treated using a plasma in this way displays improved, non-positive bonding upon the subsequent coating with a thermoplastic material in step d). In particular, gas-tight and liquid-tight components are obtained by this example method.

In a further example embodiment of the method, as shown in FIG. 2, plasma-treated intermediate layer (20) may be provided between steps c) and d) with a thin, reactive adhesive layer (25) having a thickness of a few micrometers if needed (“spray gluing”). Adhesive layer (25) is advantageously made of an epoxide adhesive. After step d), adhesive layer (25) is cured. In the case of two-component adhesives, this is frequently already possible at room temperature. After the curing, the adhesive also meets the requirements for temperature resistance and media resistance.

The sometimes strongly improved adhesion of plasma-treated intermediate layers (20) in comparison to non-plasma-treated intermediate layers (20) has been repeatedly confirmed by adhesion experiments. Several examples using oxygen plasma treatment are cited here as representative of all possible embodiments. The material identifications are type designations of commercially available plastics.

In Examples 1 through 5 material combinations were tested which are incompatible without plasma treatment, i.e., they display no or only negligibly low adhesion to one another. However, good adhesion was measured after the plasma treatment.

### EXAMPLE 1

intermediate layer (20): TPE-E layer, “Arnitel PL 380” having a thickness of 1.0 mm

thermoplastic layer (30): PA66-GF35, “Ultramid A3HG7”

plasma treatment: O₂ plasma, 2 times 180 seconds at 0.3 millibar

combined tensile and shear strength with plasma pretreatment: greater than 1.5 MPa

combined tensile and shear strength without plasma pretreatment: 0 MPa

### EXAMPLE 2

intermediate layer (20): TPE-E layer, “Hytrel 5555 HS” having a thickness of 1.0 mm

thermoplastic layer (30): PA66-GF35, “Ultramid A3HG7”

plasma treatment: O₂ plasma, 2 times 180 seconds at 0.3 millibar

combined tensile and shear strength with plasma pretreatment: greater than 6 MPa

combined tensile and shear strength without plasma pretreatment: 0 MPa

### EXAMPLE 3

intermediate layer (20): polyamide 12-GF15, “Vestamid L-GF15” having a thickness of 1.0 mm

thermoplastic layer (30): polyphenylene sulfide (PPS), “Ryton R4-200”

plasma treatment: O₂ plasma, 2 times 180 seconds at 0.3 millibar

combined tensile and shear strength with plasma pretreatment: 12.7 MPa

### EXAMPLE 4

intermediate layer (20): polyamide 12-GF15, “Vestamid L-GF15” having a thickness of 1.0 mm

thermoplastic layer (30): polyamide 46, “Stanyl TW 300”

plasma treatment: O₂ plasma, 2 times 180 seconds at 0.3 millibar

combined tensile and shear strength with plasma pretreatment: 15.9 MPa

### EXAMPLE 5

intermediate layer (20): polyamide 12-GF15, “Vestamid L-GF15” having a thickness of 1.0 mm

thermoplastic layer (30): polyphenylene sulfide (PPS), “Ryton R4-200”

plasma treatment: O₂ plasma, 2 times 180 seconds at 0.3 millibar

combined tensile and shear strength with plasma pretreatment: 4.1 MPa

### EXAMPLE 6

intermediate layer (20): polyamide 12-GF15, “Vestamid L-GF15” having a thickness of 1.0 mm

thermoplastic layer (30): polyamide 46, “Stanyl TW 300”

plasma treatment: O₂ plasma, 2 times 180 seconds at 0.3 millibar

combined tensile and shear strength with plasma pretreatment: 4.7 MPa

In following Examples 7 and 8 comparable measurements were performed with and without an additional adhesive layer (25) of a few micrometers thickness. The adhesive included “EP1”, a mixture of “Araldit LY 1413 BD” and “HY 840-1” in the ratio of 1:1. Adhesive layer (25) was cured after the extrusion coating of thermoplastic layer (30) for approximately 4 hours at 80° C. As recognizable from the measurement results, an additional adhesive layer (25) after the plasma treatment of intermediate layer (20) may further strengthen adhesion.

### EXAMPLE 7

intermediate layer (20): fluorinated silicon layer, “type 4-9060” from Dow Corning having a thickness of 1.0 mm

thermoplastic layer (30): polyamide 46, “Stanyl TW 300”

plasma treatment: O₂ plasma, 2 times 180 seconds at 0.3 millibar

combined tensile and shear strength without adhesive: 2.6 MPa

combined tensile and shear strength with adhesive: 3.2 MPa

### EXAMPLE 8

intermediate layer (20): Viton layer, “type V747” from Parker having a thickness of 1.0 mm

thermoplastic layer (30): polyphenylene sulfide (PPS), “Ryton R4-200”

plasma treatment: O₂ plasma, 2 times 180 seconds at 0.3 millibar

combined tensile and shear strength without adhesive: 0 MPa

combined tensile and shear strength with adhesive: 2.5 MPa

1-19. (canceled)

20. A method for manufacturing a component coated using a thermoplastic layer, comprising:
providing the component;
applying an intermediate layer made of a plastic to at least a part of the component;
performing a plasma treatment of the intermediate layer using a plasma gas, molecules or structure of the molecules of the intermediate layer being modified at least on a surface of the intermediate layer; and
injection molding the thermoplastic layer so that the thermoplastic layer and the component provided with the intermediate layer adhere to one another non-positively.

21. The method as recited in claim 20, wherein the component is made of a metallic or a duroplastic material.

22. The method as recited in claim 20, wherein the intermediate layer is made of one of: a thermoplastic, thermoplastic elastomer (TPE), elastomer, or cross-linked silicone.

23. The method as recited in claim 20, wherein the intermediate layer is made of a fluorinated rubber.

24. The method as recited in claim 20, wherein the intermediate layer is made of a fluorinated silicone.

25. The method as recited in claim 20, wherein the intermediate layer is made of vulcanized rubber.

26. The method as recited in claim 20, wherein the intermediate layer has a thickness of 10 μm to a few 100 μm.

27. The method as recited in claim 20, wherein the intermediate layer is plasma treated using a low-pressure plasma.

28. The method as recited in claim 27, wherein the pressure is 0.1 to 0.5 millibar.

29. The method as recited in claim 28, wherein the pressure is 0.3 millibar.

30. The method as recited in claim 20, wherein the intermediate layer is plasma treated using an atmospheric-pressure plasma.

31. The method as recited in claim 20, wherein a gas mixture or pure oxygen is used for the plasma treatment.

32. The method as recited in claim 31, wherein the gas mixture is used for the plasma treatment, the gas mixture being made of an inert carrier gas and a volatile compound.

33. The method as recited in claim 32, wherein the inert gas is argon, and the volatile compound is silane.

34. The method as recited in claim 31, wherein fragments of the plasma gas or oxygen are incorporated at least in a surface area of the intermediate layer.

35. The method as recited in claim 20, wherein molecules of the intermediate layer are transferred into a state having a higher polarity by the plasma treatment.

36. The method as recited in claim 20, wherein a structure of molecules of the intermediate layer has molecular chains which are shortened by the plasma treatment.

37. The method as recited in claim 20, wherein reactive groups are formed at least in a surface area of the intermediate layer by the plasma treatment.

38. The method as recited in claim 20, wherein the intermediate layer is provided with a thin adhesive layer having a thickness of a few μm.

39. The method as recited in claim 38, wherein the adhesive layer is made of an epoxide adhesive.

40. The method as recited in claim 38, wherein the adhesive layer is cured.
